(19) United States
(12) Patent Application Publication
(10) Pub. No.: US 2014/0176145 A1
(43) Pub. Date: Jun. 26, 2014

(54) METHOD AND APPARATUS FOR DIAGNOSING FAULT OF FUEL CELL STACK BASED ON MEASUREMENT OF STACK CURRENT

(71) Applicant: Hyundai Autron Co., Ltd., Seongnam-si (KR)

(72) Inventors: Hyun-Seok PARK, Gunpo-Si (KR); Uck-Soo KIM, Anyang-si (KR); Sun-Doo KANG, Yongin-si (KR)

(73) Assignee: Hyundai Autron Co., Ltd., Seongnam-si (KR)

(21) Appl. No.: 14/135,343

(22) Filed: Dec. 19, 2013

(30) Foreign Application Priority Data
Dec. 20, 2012 (KR) 10-2012-0149360

(51) Int. Cl. H01M 8/04

(52) U.S. Cl. CPC H01M 8/04679
USPC 324/426

(57) ABSTRACT

Provided is an apparatus and method for diagnosing a fault of a fuel cell stack based on measurement of a stack current. The apparatus includes an alternating-current (AC) generation circuit configured to apply an AC to a fuel cell stack driven by a basic operating current (direct-current: DC), a current measurement circuit configured to measure a current of the fuel cell stack caused by the DC applied to the fuel cell stack, and a Micom configured to diagnose a fault of the fuel cell stack on the basis of a current measurement result of the current measurement circuit.

### CROSS-REFERENCE TO RELATED APPLICATION

This application claims priority to Korean Patent Application No. 10-2012-0149360, filed on Dec. 20, 2012, and all the benefits accruing therefrom under 35 U.S.C. §119, the contents of which are incorporated by reference in their entirety.

### BACKGROUND

Embodiments of the present invention disclosed herein relate to a method and apparatus capable of diagnosing a fault of a fuel cell stack based on measurement of a stack current.

Fuel cells are a kind of generation devices that converts a chemical energy of a fuel into an electrical energy through an electrochemical reaction in a stack, instead of converting the chemical energy into heat by combustion. Fuel cells may be used for supplying power for industrial and home uses and for driving a vehicle, and also used for supplying power for small electrical/electronic appliances, in particular, mobile devices.

These days, polymer electrolyte membrane fuel cells (also known as proton exchange membrane fuel cell) (PEMFC) having the highest power density among various types of fuel cells are being most extensively studied as power sources for driving vehicles. PEMFC has a short start-up time and a power-conversion reaction time due to its low operating temperature.

The PEMFC includes a membrane electrode assembly (MEA) in which catalyst electrode layers where an electrochemical reaction occurs are attached to both sides of a polymer electrolyte membrane through which hydrogen ions move, a gas diffusion layer (GDL) uniformly diffusing reaction gases and delivering generated electrical energy, a gasket and coupling unit for maintaining hermeticity between the reaction gases and cooling water and a proper coupling pressure, and a bipolar plate transferring the reaction gases and the cooling water.

When a fuel cell stack is assembled by using the unit cell having the above-described structure, the MEA and GDL, main components of the cell, are disposed in the innermost portion of the cell. The MEA includes a catalyst electrode layer, that is, an anode and cathode, in which a catalyst is applied onto both sides of the polymer electrolyte membrane so as to allow hydrogen to react with oxygen. The DFL, the gasket, and the like are stacked in a portion outside a region in which the anode and cathode are placed.

The bipolar plate on which a flow field is defined is disposed on the outer portion of the DFL. The reaction gas (hydrogen as a fuel and oxygen or air as an oxidizer) is supplied and the cooling water passes through the flow field. A plurality of unit cells having the above structure are stacked, and then a current collector, an insulation plate, and an end plate for supporting the stacked cells are coupled to the outermost cell. Here, the unit cells are repeatedly stacked on and coupled to each other between the end plates to obtain a fuel cell stack.

Actually, to secure a potential as needed in vehicles, the unit cells need to be stacked as many as needed potential, and a stack means a stacked structure of the unit cells. One unit cell generates a potential of approximately 1.3 V, and a plurality of cells are stacked in series to produce power required for driving a vehicle.

Since a cell voltage is used to check a stack performance, a driving condition, and a fault, and also to variously control a system such as a flow rate control of a reaction gas in fuel cell vehicles, the cell voltage is measured by connecting a bipolar plate to a cell voltage measurement device through a connecter and a wire.

A prior art related to the present invention is disclosed in a Korean Patent Registration No. 10-1090705 (Title of the invention: Method for diagnosing condition of fuel cell stack, registered on Dec. 1, 2011).

### SUMMARY

An embodiment of the present provides method and apparatus for diagnosing faults of a fuel cell stack, the method and apparatus being capable of diagnosing the faults of the fuel cell stack through frequency analysis of a stack current.

The feature of the present invention is not limited to the aforesaid, but other features not described herein will be clearly understood by those skilled in the art from descriptions below.

In accordance with an exemplary embodiment of the present invention, an apparatus for diagnosing a fault of a fuel cell stack based on measurement of a stack current includes: an alternating-current (AC) generation circuit configured to apply an AC to a fuel cell stack driven by a basic operating current (direct-current: DC); a current measurement circuit configured to measure a current of the fuel cell stack caused by the DC applied to the fuel cell stack; and a Micom configured to diagnose a fault of the fuel cell stack on the basis of a current measurement result of the current measurement circuit.

The current measurement circuit may include a filtering unit configured to filter a current of the fuel cell stack, and measure the current of the fuel cell stack on the basis of an output signal (AC component) of the filtering unit.

The filtering unit may include a band pass filter (BPF) configured to filter a signal of a preset frequency band from the current of the fuel cell stack.

The filtering unit may include a high pass filter (HPF) configured to filter a signal of a high frequency band from the current of the fuel cell stack.

The Micom may include: a frequency conversion unit configured to frequency-convert the output signal (AC component) of the filtering unit to detect and analyze a frequency component; and an arithmetic unit configured to calculate a harmonic distortion on the basis of an analysis result of the frequency conversion unit to diagnose a fault of the fuel cell stack.

The frequency conversion unit may be configured to frequency-convert the output signal (AC component) of the filtering unit by using a fast Fourier transform (FFT).

In accordance with another exemplary embodiment of the present invention, a method for diagnosing a fault a fuel cell stack based on measurement of a stack current includes: applying, by an AC generation circuit, an AC to a fuel cell stack driven by a basic operating current (DC); measuring, by an AC generation circuit, a current of the fuel cell stack caused by the AC applied to the fuel cell stack; and diagnosing, by a Micom, the fault of the fuel cell stack on the basis of a current measured result of the current measurement circuit.

The measuring of the current of the fuel cell stack may include: filtering the current of the fuel cell stack through a filtering unit; and measuring the current of the fuel cell stack on the basis of an output signal (AC component) of the filtering unit.

The diagnosing of the fault of the fuel cell stack may include: frequency-converting the output signal (AC component) of the filtering unit through a frequency conversion unit to detect and analyze a frequency component; and calculating a harmonic distortion on the basis of an analysis result of the frequency conversion unit through an arithmetic unit to diagnose the fault of the fuel cell stack.

Advantages and features of the present invention, and implementation methods thereof will be clarified through following embodiments described with reference to the accompanying drawings. The present invention may, however, be embodied in different forms and should not be construed as limited to the embodiments set forth herein. Rather, these embodiments are provided so that this disclosure will be thorough and complete, and will fully convey the scope of the present invention to those skilled in the art. Further, the present invention is only defined by scopes of claims. Like reference numerals refer to like elements throughout.

### BRIEF DESCRIPTION OF THE DRAWINGS

Exemplary embodiments can be understood in more detail from the following description taken in conjunction with the accompanying drawings, in which:

FIG. 1 is a circuit diagram illustrating a device of diagnosing a fault of a fuel cell stack based on measurement of a stack current, in accordance with an embodiment of the present invention;

FIGS. 2 to 4 illustrate a procedure of analyzing a frequency of a stack current in order to diagnose whether the fuel cell stack fails or not, in accordance with an embodiment of the present invention; and

FIGS. 5 to 7 are flow charts illustrating methods of diagnosing a fault a fuel cell stack based on measurement of a stack current, in accordance with an embodiment of the present invention.

### DETAILED DESCRIPTION OF EMBODIMENTS

A typical fault diagnosis apparatus of a fuel cell stack determines the fault by injecting an alternating current to a stack, detecting a voltage of the stack, and calculating a total harmonic distortion (THD) using fast Fourier transform (FFT) analysis results, to detect whether the stack is broken.

When a sinusoidal current is additionally used at an operating current, a voltage of a normal cell is changed in a linear section, and a voltage of an abnormal cell is changed in a nonlinear section. Here, a current of the stack is the sum of the basic operating current and the sinusoidal current. In measurement of the voltage of the stack versus the current of the stack, the voltage of the normal cell has a low THD caused by current conversion, whereas the voltage of the abnormal cell has a broad voltage amplitude and a high THD according to a change in a cell current.

The THD is measured by the sum of the voltages of the normal cell and abnormal cell of the stack. The typical fault diagnosis apparatus of a fuel cell stack calculates the THD through frequency analysis of the stack voltage to diagnose the cell voltage, thereby determining whether the fuel cell stack fails or not.

As elements of the typical fault diagnosis apparatus of the fuel cell stack, the apparatus is constituted by three main elements, i.e., an injection unit of a stack, a measurement unit of a stack voltage, and a fault diagnosis unit.

Such a typical fault diagnosis apparatus of the fuel cell stack need to have a complicated filter design for removing a noise of vehicles and DC components to measure a voltage, and thus the structure of the typical apparatus requires a lot of parts an area of a printed circuit board (PCB) due to the complicate filter design.

Thus, an embodiment of the present invention provides method and apparatus for diagnosing a fault of a fuel cell stack, in which a voltage measurement circuit is unnecessary because THD is not calculated through measurement of a stack voltage, as disclosed in the prior art, but calculated through measurement of a stack current and FFT analysis results.

A current measurement circuit is essential to a typical fuel cell system, and thus a current measurement is performed by using a typical current sensor, thus making it possible to reduce the number of the parts and the area of the PCB.

Hereinafter, exemplary embodiments will now be described more fully with reference to the accompanying drawings.

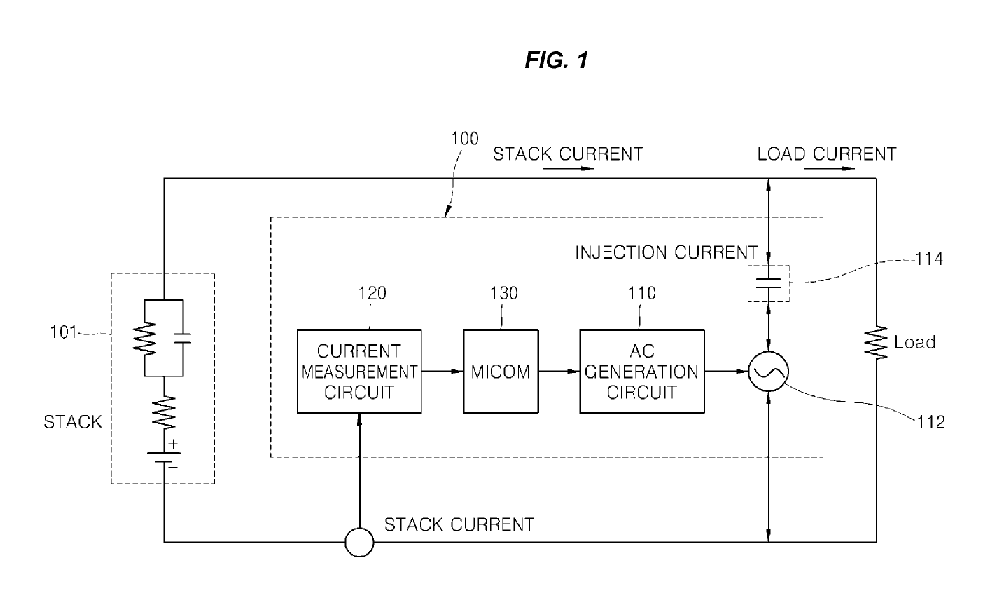

FIG. 1 is a circuit diagram illustrating an apparatus for diagnosing a fault of a fuel cell stack based on measurement of a stack current, in accordance with an embodiment of the present invention.

Referring to FIG. 1, an apparatus 100 of diagnosing a fault of a fuel cell stack based on measurement of a stack current includes an alternating-current (AC) generation circuit 110, a current measurement circuit 120, and a Micom 130.

The AC generation circuit 110 applies an AC to a fuel cell stack 101 driven by a basic operating current (direct-current: DC). Here, the AC applied to the fuel cell stack refers to an injected current shown in FIG. 1.

The AC generation circuit 110 generates the AC to apply (inject) the AC to the fuel cell stack 101 through a power source 112 and a decoupling capacitor 114.

The decoupling capacitor 114 decouples the AC and DC so as to inject the AC generated by the AC generation circuit 110 to a DC voltage of the fuel cell stack 101.

The current measurement circuit 120 measures a current of the fuel cell stack 101 caused by the AC applied to the fuel cell stack 101.

The current measurement circuit 120 may include a filtering unit (not shown) filtering the current of the fuel cell stack 101.

The current measurement circuit 120 may measure the current of the fuel cell stack 101 on the basis of an output signal (AC component) of the filtering unit. That is, the current measurement circuit 120 may measure the current of the fuel cell stack 101 by removing a DC component from the current of the fuel cell stack 101 and filtering only an AC component.

To this end, the filtering unit may include a band pass filter (BPF) filtering a signal of a preset frequency band (for example, 300 Hz) from the current of the fuel cell stack 101. Also, the filtering unit may include a high pass filter (HPF) filtering a signal of a high frequency band from the current of the fuel cell stack 101.

The Micom 130 diagnoses a fault of the fuel cell stack 101 on the basis of a current measurement result of the current measurement circuit 120.

To this end, although not shown in the drawings, the Micom 130 may include a frequency conversion unit and an arithmetic unit.

The frequency conversion unit may frequency-convert the output signal (AC component) of the filtering unit included in the current measurement circuit 120 to thereby detect and analyze a frequency component. Here, the frequency conversion unit may frequency-convert the output signal (AC component) of the filtering unit by using a fast Fourier transform (FFT).

The arithmetic unit may calculate a harmonic distortion on the basis of the analysis result of the frequency conversion unit to diagnose the fault of the fuel cell stack.

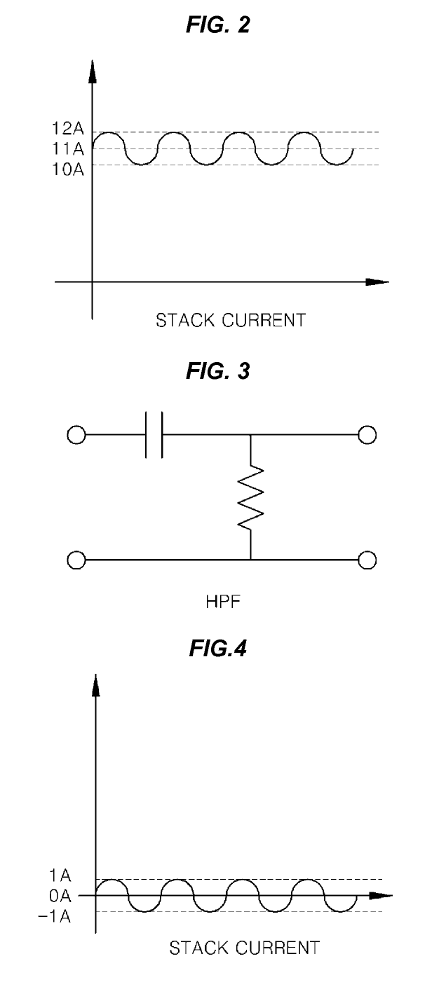

FIGS. 2 to 4 illustrate a procedure of analyzing a frequency of a stack current in order to diagnose whether the fuel cell stack fails or not, in accordance with an embodiment of the present invention.

First, the stack current of FIG. 1 is the sum of the AC and DC components as shown in FIG. 2. The stack current may be filtered through the HPF of FIG. 3, and when it passes through the HPF, the resultant stack current may have a waveform (AC component) as shown in FIG. 4. In an embodiment of the present invention, it is possible to diagnose the fault of the fuel cell stack by analyzing the frequency of the stack current of the AC component.

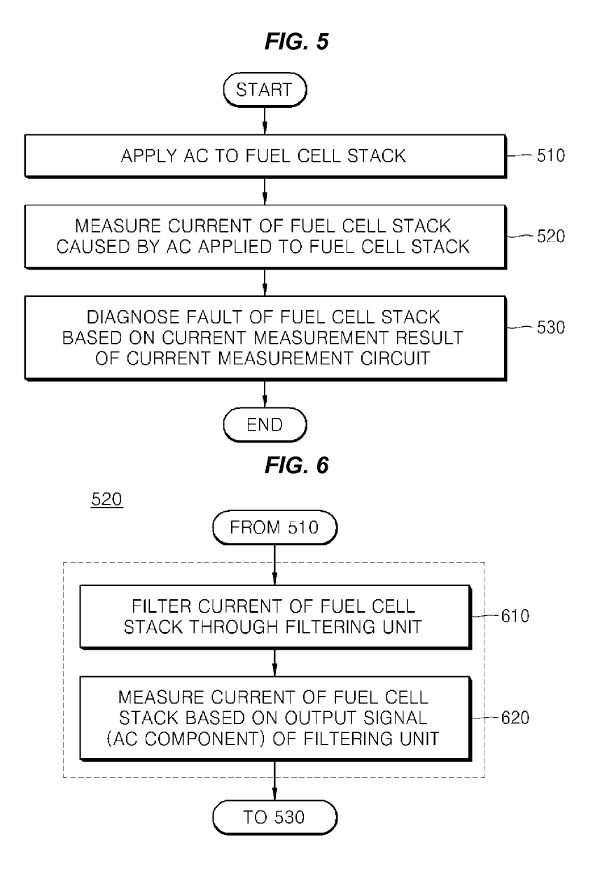

FIGS. 5 to 7 are flow charts illustrating methods of diagnosing a fault a fuel cell stack based on measurement of a stack current, in accordance with an embodiment of the present invention.

First, referring to FIGS. 1 and 5, in operation 510, the AC generation circuit 110 applies an AC to the fuel cell stack 101 driven by a basic operating current (DC).

Thereafter, in operation 520, the current measurement circuit 120 measures the current of the fuel cell stack 101 which is caused by the AC applied to the fuel cell stack 101.

Here, a process of measuring the current of the fuel cell stack 101 by the current measurement circuit 120 is described as follows.

That is, referring to FIG. 6, in operation 610, the current measurement circuit 120 filters the current of the fuel cell stack 101 through the filtering unit.

In operation 620, the current measurement circuit 120 measures the current of the fuel cell stack 101 on the basis of an output signal (AC component) of the filtering unit.

Referring again to FIGS. 1 and 5, in operation 530, the Micom 130 diagnoses a fault of the fuel cell stack 101 on the basis of a current measurement result of the current measurement circuit 120.

Here, a process of diagnosing the fault of the fuel cell stack 101 by the Micom 130 is described as follows.

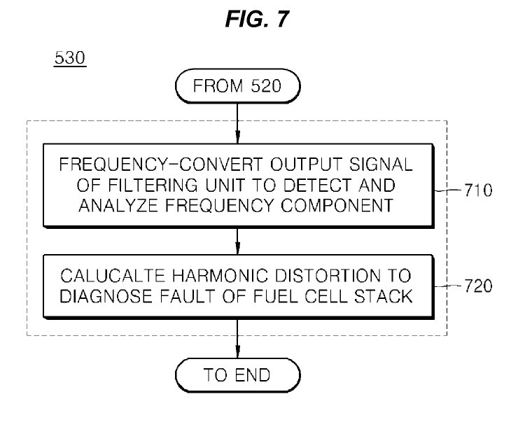

That is, referring to FIG. 7, in operation 710, the Micom 130 frequency-converts the output signal (AC component) of the filtering unit through the frequency conversion unit to detect and analyze a frequency component.

Afterwards, in operation 720, the Micom 130 diagnoses the fault of the fuel cell stack 101 by calculating THD on the basis of an analysis result of the frequency conversion unit.

As described above, the apparatus according to an embodiment of the present invention may diagnose the fault of the fuel cell stack through frequency analysis of the stack current. That is, according to an embodiment of the present invention, when the measured current of the stack passes through the HPF, only the AC component remains, and the frequency conversion and fault diagnosis may be performed by finally measuring the remaining AC component.

Since the stack voltage varies with the stack current, the fault of the stack can be diagnosed even through analysis of the stack current without a need to measure the stack voltage. Therefore, according to an embodiment of the present invention, it is possible to reduce number of parts and an area of PCB since the current is measured by using the existing current sensor (current measurement circuit).

Embodiments of the present invention include a computer-readable medium including program instructions for performing operation realized by various computers. The computer-readable medium may include program instructions, local data files, and local data alone or combinations thereof. The medium may be especially designed and configured for the present invention, or may be well-known and thus available to those skilled in the art. Examples of the computer-readable recording medium include magnetic medium such as hard disks, floppy disks, and magnetic tapes, optical recording medium such as CD-ROMs and DVDs, magnetic-optical medium such as floptical discs, and hardware devices such as read-only memory (ROM), random-access memory (RAM), and flash memory and the like to perform and store program instructions. For example, the program instruction includes a machine code made by a complier and also high-level language code to be performed by computers by using an interpreter and the like.

According to an embodiment of the present invention, diagnosis of a fault of the fuel cell stack is implemented through frequency analysis of the stack current. Therefore, the current is measured by using the existing current sensor (current measurement circuit), and thus number of components and an area of PCB can be reduced.

Although specific embodiments are described in the detailed description of the present invention, the detailed description may be amended or modified without being out of the scope of the inventive concept. Therefore, the scope of the invention is defined not by the detailed description of the invention but by the appended claims, and all differences within the scope will be construed as being included in the present invention.

As described above, although the present invention is described by the limited embodiment and drawings, the present invention is not limited to the foregoing embodiment. Further, it will be understood by those of ordinary skill in the art that various changes in form and details may be made therein. Thus, the spirit and scope of the present invention should be grasped by only the following claims, and its equal or equivalent modifications belong to the scope of the present invention.

What is claimed is:

1. An apparatus for diagnosing a fault of a fuel cell stack based on measurement of a stack current, the apparatus comprising:
an alternating-current (AC) generation circuit configured to apply an AC to a fuel cell stack driven by a basic operating current (direct-current: DC);
a current measurement circuit configured to measure a current of the fuel cell stack caused by the DC applied to the fuel cell stack; and
a Micom configured to diagnose a fault of the fuel cell stack on the basis of a current measurement result of the current measurement circuit.

2. The apparatus of claim 1, wherein the current measurement circuit comprises a filtering unit configured to filter a current of the fuel cell stack, and measures the current of the fuel cell stack on the basis of an output signal (AC component) of the filtering unit.

3. The apparatus of claim 2, wherein the filtering unit comprises a band pass filter (BPF) configured to filter a signal of a preset frequency band from the current of the fuel cell stack.

4. The apparatus of claim 2, wherein the filtering unit comprises a high pass filter (HPF) configured to filter a signal of a high frequency band from the current of the fuel cell stack.

5. The apparatus of claim 2, wherein the Micom comprises:
a frequency conversion unit configured to frequency-convert the output signal (AC component) of the filtering unit to detect and analyze a frequency component; and
an arithmetic unit configured to calculate a harmonic distortion on the basis of an analysis result of the frequency conversion unit to diagnose a fault of the fuel cell stack.

6. The apparatus of claim 5, wherein the frequency conversion unit is configured to frequency-convert the output signal (AC component) of the filtering unit by using a fast Fourier transform (FFT).

7. A method for diagnosing a fault a fuel cell stack based on measurement of a stack current, the method comprising:
applying, by an AC generation circuit, an AC to a fuel cell stack driven by a basic operating current (DC);
measuring, by an AC generation circuit, a current of the fuel cell stack caused by the AC applied to the fuel cell stack; and
diagnosing, by a Micom, the fault of the fuel cell stack on the basis of a current measured result of the current measurement circuit.

8. The method of claim 7, wherein the measuring of the current of the fuel cell stack comprises:
filtering the current of the fuel cell stack through a filtering unit; and
measuring the current of the fuel cell stack on the basis of an output signal (AC component) of the filtering unit.

9. The method of claim 7, wherein the diagnosing of the fault of the fuel cell stack comprises:
frequency-converting the output signal (AC component) of the filtering unit through a frequency conversion unit to detect and analyze a frequency component; and
calculating a harmonic distortion on the basis of an analysis result of the frequency conversion unit through an arithmetic unit to diagnose the fault of the fuel cell stack.
